(19) United States
(12) Patent Application Publication
(10) Pub. No.: US 2026/0029059 A1
(43) Pub. Date: Jan. 29, 2026

(54) ONE-PIECE COMBINATION VALVE, FUEL SYSTEM AND TEMPERATURE REGULATING CONTROL METHOD THEREOF

(71) Applicant: Chant Heat Energy Science & Technology (Zhongshan) Co., Ltd., Zhongshan (CN)

(72) Inventors: Xianmin Deng, Zhongshan (CN); Guoquan Chen, Zhongshan (CN); Weizhao Guo, Zhongshan (CN); Jiaquan Deng, Zhongshan (CN); Guangzhi Mai, Zhongshan (CN)

(21) Appl. No.: 18/904,102

(22) Filed: Oct. 2, 2024

(30) Foreign Application Priority Data
Jul. 24, 2024 (CN) 202411000976.9

(51) Int. Cl. F16K 11/22; F16K 11/24; F23D 14/02; F23N 1/00

(52) U.S. Cl. CPC F16K 11/22; F16K 11/24; F23D 14/02; F23N 1/002; F23D 2207/00; F23D 2208/10; F23N 2225/16; F23N 2235/14

(57) ABSTRACT

A one-piece combination valve, including: a valve body, provided with an air guide chamber and an air inlet chamber, the air guide chamber being configured with a first air outlet and a second air outlet; an electromagnetic valve assembly, fixedly connected to the valve body; and a plug valve assembly, connected to the valve body. A plug valve core of the plug valve assembly is driven under force to translate toward an electromagnetic valve core of the electromagnetic valve assembly and to be abutted against the electromagnetic valve core, so that the air guide chamber is in communication with the air inlet chamber, or a plug valve core of the plug valve assembly is driven under force to be rotated about a central axis of its own, so that at least one of the first air outlet and the second air outlet is/are in communication with the air guide chamber.

### CROSS-REFERENCE TO RELATED APPLICATIONS

The present disclosure claims the priority of Chinese Patent Application No. 2024110009769 filed on Jul. 24, 2024 before CNIPA. All the above are hereby incorporated by reference in their entirety.

### TECHNICAL FIELD

The present disclosure relates to the field of valves and, particularly, to a one-piece combination valve, a fuel system, and a temperature regulating control method thereof.

### BACKGROUND

The gas plug valve, due to its rapid open and close, lightweight, low fluid resistance, relatively small size, easy maintenance, and most suitable for cutting off and connecting the medium and other characteristics, is often used as the core component of the gas stove.

However, the plug valve currently on the market is mainly manually controlled, which is unable to achieve the requirements of intelligent control of the existing gas system. Therefore, the current intelligent control of the gas system typically requires a configuration of electronic control components in addition to the plug valve, resulting in a complex and large gas product structure with high cost.

### SUMMARY

In order to overcome at least one of the aforementioned defects of the prior art, provided in the present disclosure is a one-piece combination valve, a fuel system, and a temperature regulating control method thereof, which improves the intelligence of the fuel system while ensuring that the gas system is compact and simple.

The technical solutions adopted by the present disclosure to solve the problems are as follows.

A one-piece combination valve includes: a valve body, provided with an air guide chamber, an air inlet chamber, a first air outlet, and a second air outlet; an electromagnetic valve assembly, fixedly connected to the valve body; and a plug valve assembly, fixedly connected to the valve body. A plug valve core is driven under force to be rotated about a central axis of its own, so that at least one of the first air outlet and the second air outlet is/are in communication with the air guide chamber, in which the plug valve core of the plug valve assembly is translated under force toward an electromagnetic valve core of the electromagnetic valve assembly and is abutted against the electromagnetic valve core, so that the air guide chamber is in communication with the air inlet chamber.

In some implementations of the present disclosure, an air vent is configured between the air guide chamber and the air inlet chamber, an electromagnetic sealing part for sealing the air vent is configured on the electromagnetic valve core near the air vent, and the plug valve core acts on the electromagnetic valve core to drive the electromagnetic sealing part to move away from the air vent, so that the air guide chamber is in communication with the air inlet chamber.

In some implementations of the present disclosure, the plug valve core includes a valve inner core and a plug switch member, the plug switch member is provided with a plug inner chamber capable of communicating with the air guide chamber and a first opening and a second opening both capable of communicating with the plug inner chamber, and the valve inner core is inserted into and penetrates the plug switch member;

In some implementations of the present disclosure, in a closed state, a plug sidewall of the plug switch member seals the first air outlet and the second air outlet, and in an open state, one of the first opening and the second opening is at least partially in communication with the first air outlet, and the other of the first opening and the second opening is at least partially in communication with the second air outlet.

In some implementations of the present disclosure, the first opening is extended along a peripheral direction of the plug switch member.

In some implementations of the present disclosure, the valve inner core is protruded along a radial direction to form a limit protrusion, an inner wall of the air guide chamber is formed with a gear limit slot, and the limit protrusion is embedded in the gear limit slot.

In some implementations of the present disclosure, a positioning structure is formed on a peripheral sidewall of the air guide chamber, the positioning structure is configured to restrict a rotation of the limit protrusion in a peripheral direction about the valve inner core, so as to guide the limit protrusion to be embedded in the gear limit slot.

In some implementations of the present disclosure, the plug switch member is provided with a guide slide groove, the guide slide groove is extended along a central axis of the plug switch member, and the limit protrusion is configured to pass through the plug switch member and slide with respect to the guide slide groove.

In some implementations of the present disclosure, the plug valve core further includes a reset elastic member, the reset elastic member is provided between the valve inner core and the plug switch member, and the reset elastic member is configured to reset the valve inner core.

In some implementations of the present disclosure, a cross-section of the plug switch member is gradually decreased from a side distal to the air inlet chamber along a central axis of the plug switch member toward a side proximal to the air inlet chamber, and the air guide chamber is adapted to the plug switch member.

In some implementations of the present disclosure, the one-piece combination valve further includes a functional electromagnetic valve, in which the valve body is further provided with a functional air guide chamber and an air guide through-hole, the air guide chamber is in communication with the functional air guide chamber through the air guide through-hole, a movable valve core of the functional electromagnetic valve is configured to seal or open the air guide through-hole, the functional electromagnetic valve is fixedly connected to the valve body, the first air outlet is provided on the air guide chamber, and the second air outlet is provided on the functional air guide chamber.

Disclosed in the present disclosure is also a fuel system, including the one-piece combination valve mentioned above.

In some implementations of the present disclosure, a burner component configured with a thermocouple, the first air outlet and the second air outlet of the one-piece combination valve are connected to the burner component through a transporting pipeline, and the thermocouple is electrically connected to the electromagnetic valve assembly of the one-piece combination valve.

In some implementations of the present disclosure, the fuel system a directional valve provided between the burner component and the one-piece combination valve, and the directional valve is configured to change a flow of fluid fuel into the burner component.

Disclosed in the present disclosure is also a temperature regulating control method based on the fuel system mentioned above, including the following steps:
step 1A: driving the plug valve core of the plug valve assembly to be abutted against the electromagnetic valve core of the electromagnetic valve assembly, and rotating the plug valve core about a central axis of its own to be in communication with the first air outlet of the valve body, so that fluid fuel is supplied to the burner component of the fuel system; and
step 2: initiating a fire starter of the burner component to ignite the fluid fuel, the thermocouple on the burner component generates a high electrical potential to keep the electromagnetic valve core of the electromagnetic valve assembly to be in an attracted state, so that the fuel system is in a mild-flame state.

In some implementations of the present disclosure, the step 1A may be replaced to the following step 1B: driving the plug valve core of the plug valve assembly to be abutted against the electromagnetic valve core of the electromagnetic valve assembly, and driving the plug valve core to be rotated about a central axis of its own, so as to open the first air outlet and the second air outlet; and sealing the air guide through-hole of the valve body by the movable valve core of the functional electromagnetic valve, so that the fluid fuel is supplied to the burner component of the fuel system only through the first air outlet.

In some implementations of the present disclosure, the temperature regulating control method further includes the following step 3A: sending control instructions to the functional electromagnetic valve to drive the movable valve core to open the air guide through-hole, so that the fluid fuel is supplied to the burner component of the fuel system through the first air outlet and the second air outlet and the fuel system is a high-flame state.

In some implementations of the present disclosure, the temperature regulating control method further includes the following step 3B:
rotating the plug valve core about a central axis of its own until both of the first air outlet and the second air outlet of the valve body are opened, and sending control instructions to the functional electromagnetic valve to drive the movable valve core to open the air guide through-hole, so that the fluid fuel is supplied to the burner component of the fuel system through the first air outlet and the second air outlet and the fuel system is in a high-flame state.

In summary, the one-piece combination valve, the fuel system, and the temperature regulating control method thereof provided in the present disclosure provide the following technical effects:

With the ingenious utilization of the structure of the valve body in the present disclosure, the integration and assembly of the electromagnetic valve assembly and the plug valve assembly is achieved, which is conducive to the simplification of the piping and its piping components of the fuel system (i.e., the gas system as referred to in the prior art), as well as the control circuit and its electrical components, which improves the aesthetics and integration, and is conducive to the enhancement of the overall performance of the overall structure. The more important role is:

While retaining the original rapid and lightweight opening and closing characteristics of the plug valve assembly, the plug valve core of the plug valve assembly is configured to be in contact with the electromagnetic valve core of the electromagnetic valve assembly to jointly control the opening and closing control of the electromagnetic valve assembly, and the electromagnetic valve assembly is configured to receive the potential difference of the external thermocouple in order to maintain the current state or to change actions, so as to achieve the automation and control of the one-piece combination valve, which is conducive to the intelligence of the fuel system.

Additionally, the combination of the electromagnetic valve assembly and the plug valve assembly allows for better prevention of fuel leakage to achieve a double protection effect. Also, the electromagnetic valve assembly is reset to close by itself when not receiving a potential difference from an external thermocouple, thereby effectively improving the safety and stability of the one-piece combination valve and the fuel system thereof.

### BRIEF DESCRIPTION OF THE DRAWINGS

FIG. 1 is a first overall structural diagram of a one-piece combination valve of the present disclosure;

FIG. 2 is a second overall structural diagram of the one-piece combination valve of the present disclosure;

FIG. 3 is a structural diagram in a partial exploded view of the plug valve assembly of the present disclosure;

FIG. 4 is a schematic diagram in a first top view of the one-piece combination valve of the present disclosure;

FIG. 5 is a schematic diagram in a sectional view of FIG. 4 at A-A;

FIG. 6 is a schematic diagram illustrating a rotated position of the valve inner core in FIG. 5;

FIG. 7 is a schematic diagram in a second top view of the one-piece combination valve of the present disclosure;

FIG. 8 is a schematic diagram in a sectional view of FIG. 7 at B-B;

FIG. 9 is a schematic diagram illustrating a rotated position of the valve inner core in FIG. 8;

FIG. 10 is a schematic diagram of a third top view of the one-piece combination valve of the present disclosure;

FIG. 11 is a schematic diagram in a sectional view of FIG. 10 at C-C;

FIG. 12 is a schematic diagram of a fourth top view of the one-piece combination valve of the present disclosure;

FIG. 13 is a schematic diagram in a sectional view of FIG. 12 at D-D;

FIG. 14 is a schematic diagram illustrating a rotated position of the valve inner core in FIG. 13;

Labels: 1 valve body; 11 air guide chamber; 12 air guide chamber; 13 first air outlet; 14 second air outlet; 15 inlet vent; 16 air vent; 17 functional air guide chamber; 18 air guide through-hole; 2 electromagnetic valve assembly; 21 electromagnetic valve seat; 22 electromagnetic valve core; 23 electromagnetic sealing part; 3 plug valve assembly; 31 plug valve core; 311 valve inner core; 312 plug switch member; 313 reset spring; 314 limit retaining element; 32 plug valve seat; 33 first opening; 34 second opening; 351 limit protrusion; 352 gear limit slot; 36 positioning structure; 37 guide slide groove; 4 functional electromagnetic valve; 41 movable valve core.

### DETAILED DESCRIPTION

For a better understanding and implementation, the technical solutions in the embodiments of the present disclosure are clearly and completely described below in conjunction with the attached drawings of the present disclosure.

In the description of the present disclosure, it is to be noted that the terms “up”, “down”, “front”, “back”, “left”, “right”, “vertical”, “horizontal”, “top”, “bottom”, “inside”, “outside” and other orientation or position relationships are based on the orientation or position relationships shown in the attached drawings. It is only intended to facilitate description of the present disclosure and simplify description, but not to indicate or imply that the referred device or element has a specific orientation, or is constructed and operated in a specific orientation. Therefore, they should not be construed as a limitation of the present disclosure.

Unless otherwise defined, all terms including technical and scientific terms used herein have the same meaning as commonly understood by those skilled in the art to which the present disclosure belongs. The terms used herein in the specification of the present disclosure are used only to describe specific embodiments and are not intended as a limitation of the disclosure.

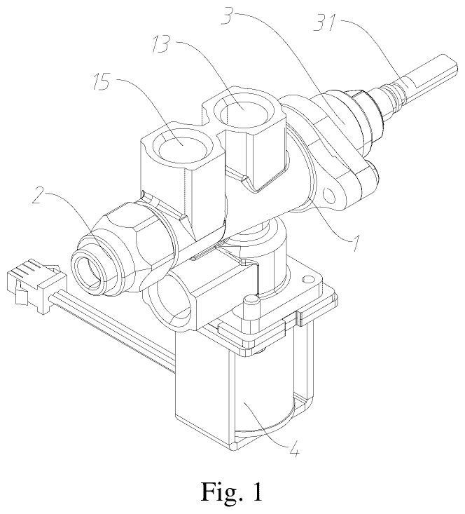

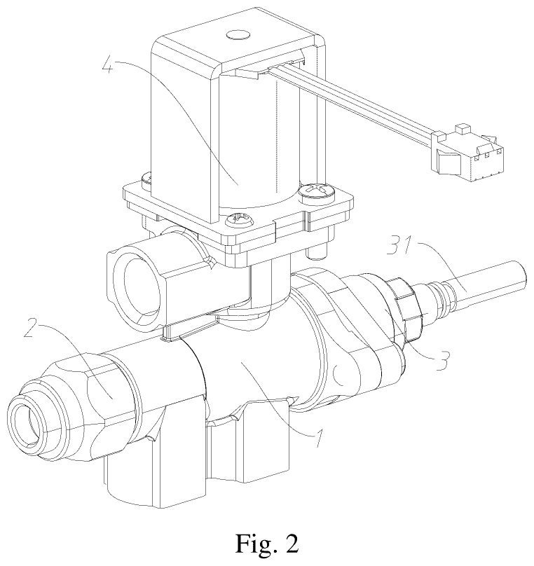

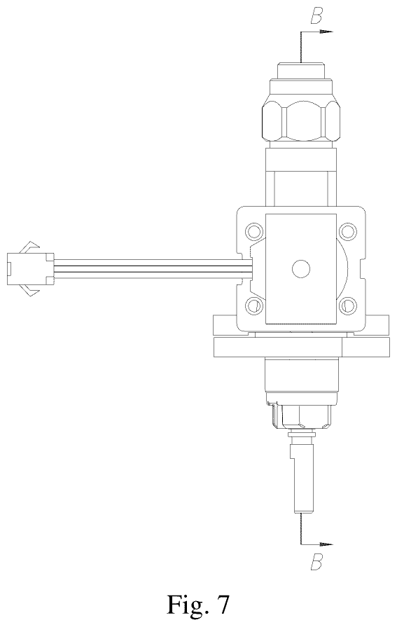

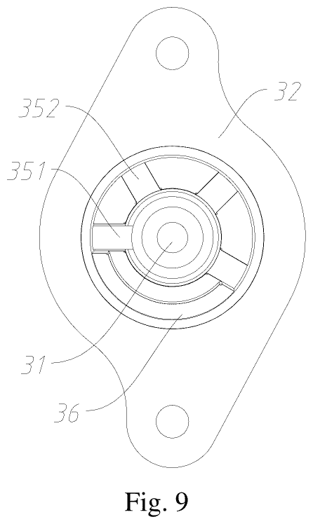

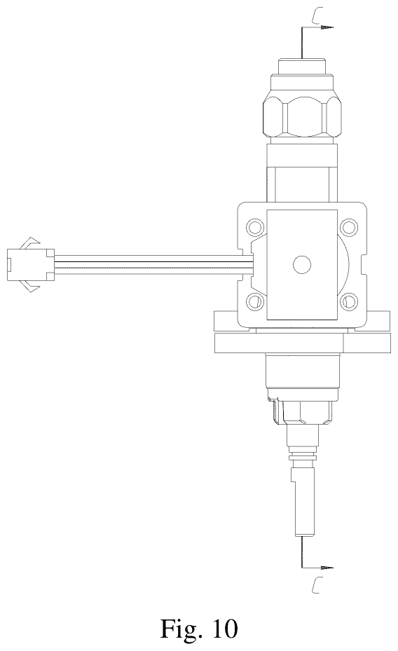

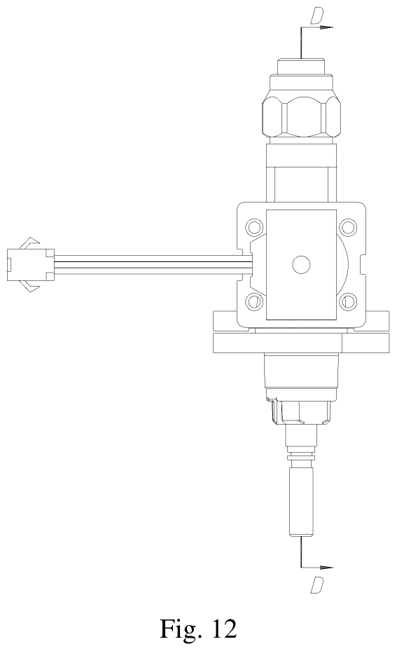

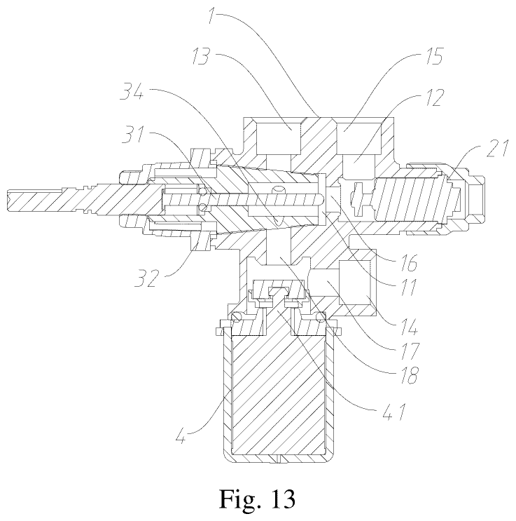

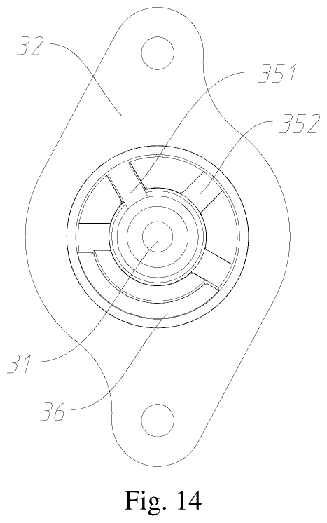

Referring to FIGS. 1 to 14 for details, in some embodiments, disclosed in the present disclosure is a one-piece combination valve, including a valve body 1, an electromagnetic valve assembly 2, and a plug valve assembly 3, in which the valve body 1 is made by a one-piece molding process, such as an injection molding process. Admittedly, the valve body 1 may also be made in combination with a welding process, so that the valve body 1 requires no assembly connection, thereby simplifying the overall assembly process of the one-piece combination valve, and improving the overall airtightness, stability and safety of the valve body 1. Additionally, it is conducive to improving the overall structural strength of the valve body 1, reducing the wall thickness at the splicing position, and simplifying the structure of the valve body 1, thereby facilitating the reduction of the volume of the one-piece combination valve.

Further, referring to FIGS. 1 to 13 for details, the valve body 1 is provided with an air guide chamber 11, an air inlet chamber 12, a first air outlet 13, and a second air outlet 14. The air guide chamber 11 is in communication with the air inlet chamber 12, and the air inlet chamber 12 is configured with an inlet vent 15. When the inlet vent 15 of the one-piece combination valve is connected to a feeding device (such as a gas storage tank and a liquefied petroleum supply equipment), the fluid fuel (gas or liquefied fuel) supplied by the feeding device is conveyed into the air inlet chamber 12 through the inlet vent 15 and flows into the air guide chamber 11. Both of the first air outlet 13 and the second air outlet 14 are in communication with the air guide chamber 11, so that the fluid fuel may be conveyed to the one-piece combination valve through the first air outlet 13 and the second air outlet 14, and be supplied to corresponding different burner components in the same or different devices.

In the present embodiment, referring to FIGS. 1 to 13, the electromagnetic valve in the electromagnetic valve assembly 2 is of mature prior art in the field, an industrial device that is controlled by electromagnetism, and also an automation basic element configured to control fluids. The model and type of the electromagnetic valves may be selected according to the actual demands and other factors, and are not limited herein.

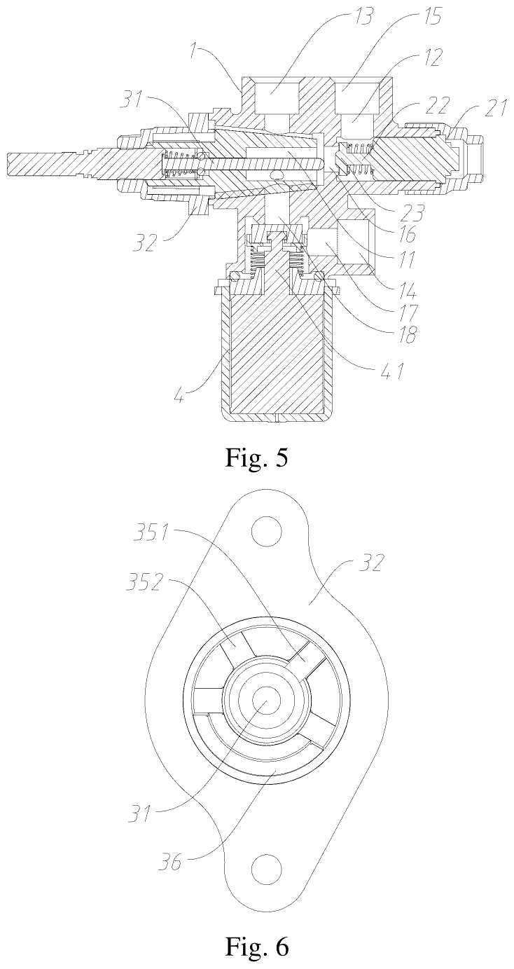

Specifically, referring to FIGS. 5, 8, 11, and 13, the electromagnetic valve is provided with an electromagnetic valve seat 21 and an electromagnetic valve core 22 extendable and movable in the electromagnetic valve seat 21, the electromagnetic valve seat 21 of the electromagnetic valve assembly 2 is fixedly connected to the valve body 1, and the electromagnetic valve core 22 is able to be translated from the inlet vent 15 toward an interior side of the air inlet chamber 12. An air vent 16 is configured between the air guide chamber 11 and the air inlet chamber 12, and the air guide chamber 11 is in communication with the air inlet chamber 12 through the air vent 16. When completing the assembly of mounting the electromagnetic valve, the electromagnetic valve core 22 is translated toward the interior side of the air inlet chamber 12 until it is abutted against the air vent 16, so as to seal the air vent and interrupt the flow of fluid fuel from the air inlet chamber 12 to the air guide chamber 11.

It should be noted that the air vent 16 is normally a circular through-hole, but is not limited to the circular through-hole, and may be a through-hole of rectangular, oval, or other shapes. An electromagnetic sealing part 23 for sealing the air vent 16 is configured on the electromagnetic valve core 22 near the air vent 16, and the air vent 16 is positioned within the coverage of the electromagnetic sealing part 23 in a direction along the center axis of the electromagnetic valve core 22, so as to improve the sealing of the electromagnetic valve core 22 when sealing the air vent 16.

In an embodiment, considering to further improve the sealing between the electromagnetic valve core 22 and the air vent 16, at least one of the following is met: (a) a side of the electromagnetic sealing part 23 proximal to the air vent 16 is provided with a sealing rubber layer, and (b) a peripheral side of the electromagnetic sealing part 23 is provided with a sealing rubber ring. Additionally, the elasticity and plasticity of at least one of the following: (a) the sealing rubber layer; and (b) the sealing rubber ring, may also prevent a rigid contact between the electromagnetic sealing part 23 of the electromagnetic valve core 22 and the air vent 16, thereby avoiding noise and damage caused by collisions between the electromagnetic valve assembly 2 and the valve body 1 during use.

It should also be noted that, the electromagnetic valve is configured to be electrically connected to an external thermocouple, so as to achieve a precise and flexible control of the electromagnetic valve core 22 in at least one of the following: (a) performing an action; and (b) maintaining the current state. Specifically, it may be helpful to understand how the electromagnetic valve or the electromagnetic valve assembly 2 works and functions in the embodiment in light of the following.

As a core solution of the present embodiment is that, referring to FIGS. 1 to 13 for details, the plug valve assembly 3 mentioned above is fixedly connected to the valve body 1. Specifically, the plug valve seat 32 of the plug valve assembly 3 is fixedly connected to the valve body 1, and the plug valve core 31 is configured within the plug valve seat 32. Additionally, the plug valve core 31 of the plug valve assembly 3 is translated under force toward an electromagnetic valve core 22 of the electromagnetic valve assembly 2 and is abutted against the electromagnetic valve core 22, so that the air guide chamber 11 is in communication with the air inlet chamber 12.

It may be understood that, the plug valve core 31 acts on the electromagnetic valve core 22, i.e., the operator applies a force to the plug valve core 31 to drive the plug valve core 31 of the plug valve assembly 3 to translate toward the electromagnetic valve core 22 of the electromagnetic valve assembly 2, and the force applied to the plug valve core 31 is transferred to the electromagnetic valve core 22 when the plug valve core 31 is abutted against the electromagnetic valve core 22, so as to drive the electromagnetic valve core 22 to perform a retracted movement to reset. At this point, the electromagnetic sealing part 23 moves away from the air vent 16, and the air guide chamber 11 is in communication with the air inlet chamber 12, so that the fluid fuel flows quickly from the air inlet chamber 12 to the air guide chamber 11 and fills with the entire air guide chamber 11.

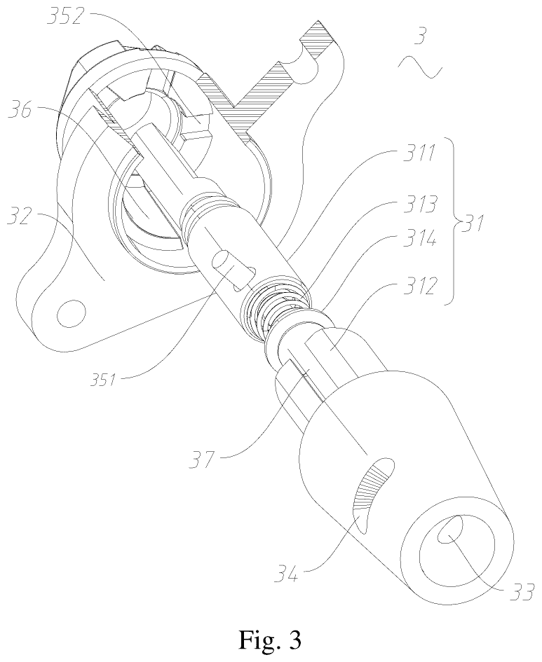

Additionally, referring to FIGS. 3, 8, 11, and 13 for details, the plug valve core 31 is rotated under force about a central axis of its own, that is, the operator applies a turning torque to rotate the plug valve core 31. The plug valve core 31 is provided with a first opening 33 and a second opening 34. With the rotation of the plug valve core 31, both of the first opening 33 and a second opening 34 are also rotated about the central axis of the plug valve core 31. When the first opening 33 is at least partially overlapping with the first air outlet 13 in a radial direction of the plug valve core 31, the first air outlet 13 is in communication with the air guide chamber 11. Similarly, when the second opening 34 is at least partially overlapping with the second air outlet 14 in the radial direction of the plug valve core 31, the second air outlet 14 is in communication with the air guide chamber 11. It is herein complementarily noted that when the first opening 33 is in communication with the first air outlet 13, the second opening 34 is in communication with the second air outlet 14 synchronously. In such an arrangement, at least one of the first air outlet 13 and the second air outlet 14 is in communication with the air guide chamber 11.

It should be understood that the plug valve core 31 may be rotated at any angles. In such arrangement, when the first opening 33 is at least partially overlapping with the second air outlet 14 in the radial direction of the plug valve core 31, the second air outlet 14 is in communication with the air guide chamber 11 through the first opening 33. Correspondingly, the second opening 34 is at least partially overlapping with the first air outlet 13 in a radial direction of the plug valve core 31, the first air outlet 13 is in communication with the air guide chamber 11 through the second opening 34.

The unexpected effect is that a simple rotation of the plug valve core 31 allows for the discharge of the fluid fuel by a single outlet of one of the first air outlet 13 and the second air outlet 14, or both of the first air outlet 13 and the second air outlet 14 simultaneously, which is simple to switch and easy to operate.

It should be noted that the positions of the first air outlet 13 and the second air outlet 14 may be set and adjusted according to structural design and design requirements. The first air outlet 13 and the second air outlet 14 are not specifically limited in the present embodiment, which are also not limited to their sizes and shapes of the openings.

In the above, a force may be applied to the plug valve core 31 to drive the electromagnetic valve core 22 to be reciprocally translated, and then a rotational torque may be applied to the plug valve core 31 to drive the plug valve core 31 to be rotated about a central axis of its own. Alternatively, a rotational torque may be applied to the plug valve core 31 to drive the plug valve core 31 to be rotated about a central axis of its own, and then a force may be applied to the plug valve core 31 to drive the electromagnetic valve core 22 to be reciprocally translated. Alternatively, A force and a rotational torque may be applied to the plug valve core 31 simultaneously, so as to drive the plug valve core 31 to be reciprocally translated and rotated about a central axis of its own.

As a preferable implementation, referring to FIG. 3 for details, the plug valve core 31 includes a valve inner core 311 and a plug switch member 312, the plug switch member 312 is provided with a plug inner chamber capable of communicating with the air guide chamber 11, and both of the first opening 33 and the second opening 34 are provided on the plug switch member 312. That is, the fluid fuel flows from the air vent 16 to the air guide chamber 11 and then is conveyed to and filled within the plug inner chamber. In an implementation, the shape dimension of the plug switch member 312 is smaller than that of the air guide chamber 11, or the size of the plug switch member 312 is less than that of the air guide chamber 11 within the assembly tolerance, allowing the plug sidewall of the plug switch member 312 to be abutted against the inner chamber wall of the air guide chamber 11.

After finishing the rotation of the plug valve assembly 3, the plug wall of the plug switch member 312 seals the first air outlet 13 and the second air outlet 14. Specifically, both of the first opening 33 and the second opening 34 are misaligned with the first air outlet 1 and both of the first opening 33 and the second opening 34 are misaligned with the second air outlet 14, and thus the inner chamber wall of the air guide chamber 11 seals the first opening 33 and the second opening 34, so as to prevent the liquid fuel from flowing out from the first air outlet 13 and the second air outlet 14. At this point, the one-piece combination valve is in a closed state.

Further, referring to FIGS. 3, 8, 11, and 13 for details, the valve inner core 311 is inserted into and penetrates the plug switch member 312, the valve inner core 311 slides with respect to the plug switch member 312 along the central axis of the plug switch member 312, and an end of the valve inner core 311 proximal to the air vent 16 passes through the air vent 16 and is abutted against the electromagnetic valve core 22. Since the plug sidewall of the plug switch member 312 is abutted against the inner chamber wall of the air guide chamber 11, the plug switch member 312 is stationary with respect to the valve body 1. When a rotational torque is applied to the valve inner core 311, the plug switch member 312 is driven to be rotated. The first opening 33 or the second opening 34 is at least partially overlapping with the first air outlet 13 in a radial direction of the plug valve core 31, that is, when one of the first opening 33 and the second opening 34 is at least partially in communication with the first air outlet 13, the first air outlet 13 is in communication with the air guide chamber 11. Similarly, the other of the first opening 33 and the second opening 34 is at least partially overlapping with the second air outlet 14 in the radial direction of the plug valve core 31, that is, when the other of the first opening 33 and the second opening 34 is at least partially in communication with the second air outlet 14, the second air outlet is in communication with the air guide chamber 11.

Preferably, the first opening 33 is extended along a peripheral direction of the plug switch member 312, i.e., the first opening is formed as a through slot. When inaccuracy occurs in the rotation of the plug switch member 312, it is still possible to ensure that the first air outlet 13 or the second air outlet 14 is positioned entirely within the coverage area of the first air outlet 13 or the second air outlet 14, thereby ensuring that the fluid fuel flowing through the first air outlet 13 or the second air outlet 14 is steadily at a maximum amount.

In order to switch more conveniently and with more precise control between discharging and delivering fluid fuel from one of the first air outlet 13 and the second air outlet 14 in a single opening, and discharging and delivering fluid fuel from both of the first air outlet 13 and the second air outlet 14 simultaneously, the inventors also provide a preferred implementation as follows:

Referring to FIGS. 3, 6, 9, and 14 for details, the valve inner core 311 is provided with a limit protrusion 351, which is protruded along a radial direction of the limit protrusion 351. Optionally the limit protrusion 351 may be integrally molded with the valve inner core 311, welded to the valve inner core 311, threaded to the valve inner core 311, or plugged in connection with the valve inner core 311. The inner chamber wall of the air guide chamber 11 is formed with a gear limit slot 352, the gear limit slot 352 is extended toward a radial direction of the air guide chamber, and the limit protrusion 351 is embedded in the gear limit slot 352.

It should be noted that it is preferably to configure with a plurality of gear limit slots 352, and the plurality of gear limit slots 352 is arranged about an axial direction of the air guide chamber 11. In the present implementation, it is to configure with four gear limit slots 352. The four gear limit slots 352 are sequentially defined as a first gear slot, a second gear slot, a third gear slot, and a fourth gear slot. When the limit protrusion 351 is engaged with the first gear slot, both of the first air outlet 13 and second air outlet 14 discharge and convey the fluid fuel simultaneously. When the limit protrusion 351 fits in the second gear slot, one of the first air outlet 13 and the second air outlet 14 discharges and conveys the fluid fuel separately. When the limit protrusion 351 fits in the third gear slot, both of the first air outlet 13 and the second air outlet 14 are unable to discharge and convey the fluid fuel. When the limit protrusion 351 fits in the fourth gear slot, both of the first air outlet 13 and the second air outlet 14 discharge and convey the fluid fuel simultaneously.

In an implementation, referring to FIGS. 3, 6, 9, and 14 for details, the peripheral sidewall of the air guide chamber 11 is formed with a positioning structure 36, in which the positioning structure 36 is extended along a peripheral direction of the air guide chamber 11, an end of the positioning structure 36 is preferably positioned on a side of the first gear slot, an opposite end of the positioning structure 36 is positioned on a side of the fourth gear slot, and the the positioning structure 36 is configured to restrict the rotation of the limit protrusion 351 in a peripheral direction about the valve inner core 311, so as to guide the limit protrusion 351 to be embedded in the gear limit slots 352.

That is, when the limit protrusion 351 is rotated with the valve inner core 311 and is abutted against the positioning structure 36, it is blocked by the positioning structure 36, and both the limit protrusion 351 and the valve inner core 311 are unable to be rotated further even if a rotational torque is provided. At this point, the limit protrusion 351 may be positioned into the first gear slot or the fourth gear slot more quickly and accurately, and control that one of the first opening 33 and the second opening 34 on the plug switch member 312 is aligned with the first air outlet 13, and the other of the first opening 33 and the second opening 34 is aligned with the second air outlet 14, so as to achieve that both of the first air outlet 13 and the second air outlet 14 discharge and convey the fluid fuel simultaneously, thereby further improving the ease of operation of the one-piece combination valve.

In other implementations, a full rotation of the valve inner core 311 may be preserved. For facilitating the limit protrusion 351 to be positioned into the gear limit slot 352 more quickly and accurately, a positioning scale may be provided on an exterior surface of the plug valve seat 32, and an operator rotating to a corresponding positioning scale enables the limit protrusion 351 to be embedded into a corresponding gear limit slot 352. Admittedly, the positioning scale may be used in conjunction with the positioning structure 36.

Further, referring to FIG. 3 for details, the plug switch member 312 is provided with a guide slide groove 37, the guide slide groove 37 is extended along a central axis of the plug switch member 312, an end of the guide slide groove 37 penetrates the plug switch member 312, and the limit protrusion 351 is configured to pass through the plug switch member 312 and slide with respect to the guide slide groove 37.

In such an arrangement, when a force is applied to the valve inner core 311 to drive the valve inner core 311 to move or translate, the limit protrusion 351 slides from an end of the guide slide groove 37 to an interior of the guide slide groove 37. Guiding by the cooperation of the guide slide groove 37 and the limit protrusion 351, the plug valve core 31 can be translated accurately and steadily toward the electromagnetic valve core 22 of the electromagnetic valve assembly 2. Additionally, when applying a rotational torque to the valve inner core 311, under the cooperation of the guide slide groove 37 and the limit protrusion 351, the rotational torque applied to the valve inner core 311 is transferred to the plug switch member 312 under the action of the limit protrusion 351, so that the plug switch member 312 and the valve inner core 311 are rotated synchronously.

As a preferable implementation, referring to FIG. 3 for details, the plug valve core 31 further includes a reset elastic member, the reset elastic member is provided between the valve inner core 311 and the plug switch member 312, and the reset elastic member is configured to reset the valve inner core 311. The reset elastic member herein includes a reset spring 313 and a limit retaining element 314. The limit retaining element 314 is snap-fitted to the plug switch member 312, an end of the reset spring is abutted against the limit retaining element 314, and an opposite end of the reset spring is abutted against an end of the valve inner core 311. When a force is applied to the valve inner core 311 to drive the valve inner core 311 to translate toward the electromagnetic valve core 22 of the electromagnetic valve assembly 2, the reset spring 313 of the reset elastic member is compressed.

In such an arrangement, when the force applied to the valve inner core 311 is withdrawn, the electromagnetic valve core 22 reset automatically under the deformation restoration force of the reset spring 313. Additionally, under the action of the reset spring 313 of the reset elastic member, no risk of collision may occur due to no rigid contact between the valve inner core 311 and the plug switch member 312, which achieves a buffering effect.

As a preferable implementation, referring to FIGS. 3, 8, 11, and 13 for details, a cross-section of the plug switch member 312 is gradually decreased from a side distal to the air inlet chamber 12 toward a side proximal to the air inlet chamber 12 along a central axis of the plug switch member 312, that is, the peripheral side of the plug switch member 312 is formed into a positioning conical surface, and the air guide chamber 11 is adapted to the plug switch member 312. In such an arrangement, a positioning conical surface allows the plug switch member 312 and the plug valve assembly 3 to assemble to the air guide chamber 11 of the valve body 1 more quickly and accurately.

In the above, the operator may apply a rotational torque to the plug valve core 31 of the plug valve assembly 3 to freely and manually switch between discharging and conveying the fluid fuel through one of the first air outlet 13 and the second air outlet 14 separately, and discharging and conveying the fluid fuel through both of the first air outlet 13 and the second air outlet 14 simultaneously. Also, by means of the cooperation of the plug valve assembly 3 with the electromagnetic valve assembly 2, not only is a double sealing effect achieved, but also the external thermocouple is unable to form an electric potential to induce the electromagnetic valve core 22 to maintain the current state in an unignited state, so that the electromagnetic valve core 22 seals the air vent 16 to disrupting the flow of the fluid flow from the air inlet chamber 12 to the air guide chamber 11, stopping the supply of the fluid fuel, which greatly improves the safety of the one-piece combination valve.

In some special cases, the operator is not nearby the one-piece combination valve and is unable to switch manually in time, and the one-piece combination valve is in a state that both the first air outlet 13 and the second air outlet 14 discharge and convey the fluid fuel simultaneously, which leads to a reduction in the supply of the fluid fuel due to high ambient temperatures. At this point, the operator is unable to switch from discharging and conveying the fluid fuel through both of the first air outlet 13 and the second air outlet 14 simultaneously to discharging and conveying the fluid fuel through one of the first air outlet 13 and the second air outlet 14 separately, which leads to a continuous increase in the ambient temperature that may significantly exceed the set temperature.

In view of the existing issues mentioned above, provided by the inventors is further a preferable implementation, referring to FIGS. 1, 2, 8, 11, and 13 for details, the one-piece combination valve further includes a functional electromagnetic valve 4, in which the valve body 1 is further provided with a functional air guide chamber 17 and an air guide through-hole 18, the air guide chamber 11 is in communication with the functional air guide chamber 17 through the air guide through-hole 18, a movable valve core 41 of the functional electromagnetic valve 4 is configured to seal or open the air guide through-hole 18, the functional electromagnetic valve 4 is fixedly connected to the valve body 1, the first air outlet 13 is provided on the air guide chamber 11, and the second air outlet 14 is provided on the functional air guide chamber 17.

Specifically, the functional electromagnetic valve 4 is also of mature prior art in the field, an industrial device that is controlled by electromagnetism, and also an automation basic element configured to control fluids. The model and type of the electromagnetic valves may be selected according to the actual demands and other factors, and are not limited herein.

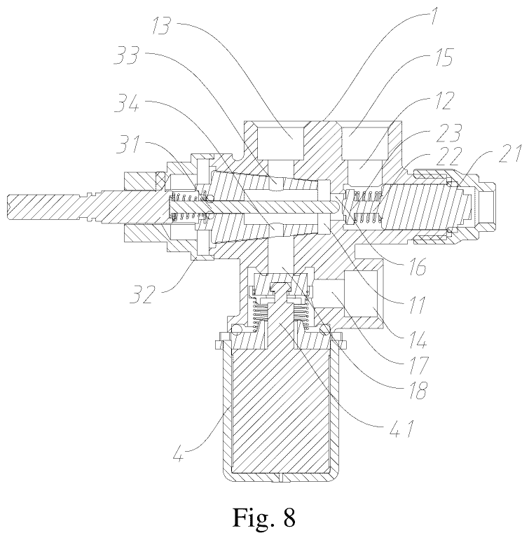

Referring to FIGS. 8, 11, and 13, the functional electromagnetic valve 4 is electrically connected an external thermocouple or an external control center. When the ambient temperature is over than a set temperature, the functional electromagnetic valve 4 receives a control command to drive the movable valve core 41 to seal the air guide through-hole 18, so that the fluid fuel is unable to flow to the functional air guide chamber 17 through the air guide through-hole 18, and is only able to be transferred out of the one-piece combination valve from the first air outlet 13 to maintain a continuous supply of the fluid fuel. In this way, an automatic switch is achieved from discharging and conveying the fluid fuel through both of the first air outlet 13 and the second air outlet 14 simultaneously to discharging and conveying the fluid fuel through one of the first air outlet 13 and the second air outlet 14 separately, so as to reduce the supply of the fluid fuel, which effectively lowers the ambient temperature, and is conducive to keeping the ambient temperature at an optimal temperature range.

In such an arrangement, in addition to blocking the entry of the fluid fuel into the functional air guide chamber 17, i.e. blocking the supply of the fluid fuel through the output of the second air outlet 14, by means of the plug valve core 31 of the plug valve assembly 3, it is also possible to block the supply of the fluid fuel through the output of the second air outlet 14 by means of the functional electromagnetic valve 4 sealing off the air guide through-hole 18, so as to achieve the double blocking of the fluid fuel from being discharged.

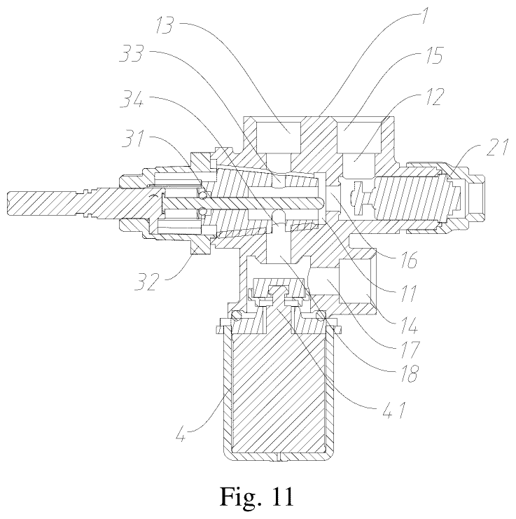

In other implementations, when the operator assumes that the ambient temperature approaches a set upper limit temperature, or the operator feels a relatively high temperature, referring to FIG. 11, the operator may apply a rotational torque to the plug valve core 31 of the plug valve assembly 3, so as to switch from discharging and conveying the fluid fuel through both of the first air outlet 13 and the second air outlet 14 simultaneously to discharging and conveying the fluid fuel through one of the first air outlet 13 and the second air outlet 14 separately.

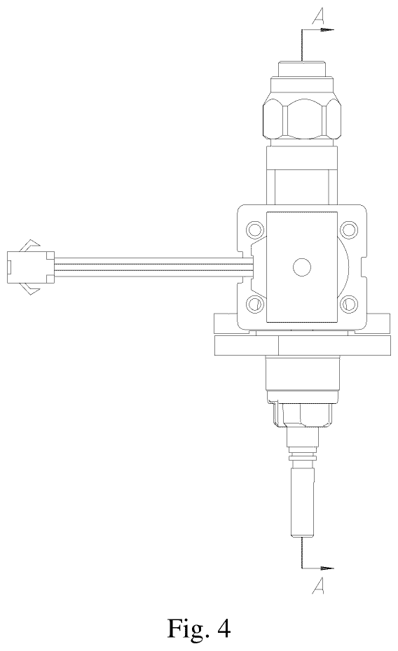

Summarizing the above structure and connection relationship of the one-piece combination valve, and referring to FIGS. 4 to 14, the inventors provide a temperature regulating control method based on the above one-piece combination valve as follows:
step 1A: driving the plug valve core 31 of the plug valve assembly 3 to be abutted against the electromagnetic valve core 22 of the electromagnetic valve assembly 2, and rotating the plug valve core 31 about a central axis of its own to be in communication with the first air outlet 13 of the valve body 1, so that fluid fuel is supplied to the burner component of the fuel system; and
step 2: initiating a fire starter of the burner component to ignite the fluid fuel, the thermocouple on the burner component generates a high electrical potential to keep the electromagnetic valve core 22 of the electromagnetic valve assembly 2 to be in an attracted state, so that the fuel system is in a mild-flame state.

It should be noted that prior to performing step 1A, the one-piece combination valve described above is connected and assembled in the fuel system via a conveying piping connection, and the work of inspection is accomplished to ensure the safety of use.

It should also be noted the mild-flame state of the fuel system may be heating for a small fire to allow the ambient temperature to continuously and slowly increase, and may also be heating for a small fire to allow the ambient temperature to be kept in a better or optimal temperature range, which consumes less fluid fuel and avoids the occurrence of a sudden heat in the ambient temperature.

Further, when it is necessary to enlarge the fire power of the burner component to allow the lower ambient temperature to be restored to a better or optimal temperature range, The inventors also add a further preferred implementation based on the above temperature regulating control method as follows:
the method further includes step 3B as follows:
rotating the plug valve core 31 about a central axis of its own until both of the first air outlet 13 and the second air outlet 14 of the valve body 1 are opened, and sending control instructions to the functional electromagnetic valve 4 to drive the movable valve core 41 to open the air guide through-hole 18, so that the fluid fuel is supplied to the burner component of the fuel system through the first air outlet 13 and the second air outlet 14 and the fuel system is in a high-flame state.

Admittedly, in addition to the temperature regulating control method mentioned above, provided by the inventors is further another preferable implementation as follows:
step 1B: driving the plug valve core 31 of the plug valve assembly 3 to be abutted against the electromagnetic valve core 22 of the electromagnetic valve assembly 2, and driving the plug valve core 31 to be rotated about a central axis of its own, so as to open the first air outlet 13 and the second air outlet 14; and sealing the air guide through-hole 18 of the valve body 1 by the movable valve core 41 of the functional electromagnetic valve 4, so that the fluid fuel is supplied to the burner component of the fuel system only through the first air outlet 13; and
step 2: initiating a fire starter of the burner component to ignite the fluid fuel, the thermocouple on the burner component generates a high electrical potential to keep the electromagnetic valve core 22 of the electromagnetic valve assembly 2 to be in an attracted state, so that the fuel system is in a mild-flame state.

At the moment, when it is necessary to enlarge the fire power of the burner component to allow the lower ambient temperature to be restored to a better or optimal temperature range, the above step 3B is correspondingly replaced with step 3A:
sending control instructions to the functional electromagnetic valve 4 to drive the movable valve core 41 to open the air guide through-hole 18, so that the fluid fuel is supplied to the burner component of the fuel system through the first air outlet 13 and the second air outlet 14 and the fuel system is in a high-flame state.

Based the above structure and connection relationship of the one-piece combination valve, the inventors also provide a fuel system, and the fuel system includes the one-piece combination valve, so as to attribute to the piping connection in the fuel system and the simplification of the piping components, thereby decreasing the cost and assembly difficulty of the fuel system and other related devices thereof, and is more conducive to the repair and maintenance the fuel system.

It should be noted that the heat supply device herein is a gas heater, optionally a gas cook appliance, or a gas air conditioner, or a gas water heater.

Specifically, a burner component configured with an electric thermocouple, the first air outlet 13 and the second air outlet 14 of the one-piece combination valve are connected to the burner component through a transporting pipeline, and the electric thermocouple is electrically connected to the electromagnetic valve assembly 2 of the one-piece combination valve.

In such an arrangement, by applying a force and a rotational torque to the plug valve assembly 3 of the one-piece combination valve, the plug valve core 31 of the plug valve assembly 3 pushes the electromagnetic valve core 22 of the electromagnetic valve assembly 2 to conduct at least one of the following: (a) the first air outlet 13; and (b) the second air outlet 14, so that the fluid fuel flows through the air guide chamber 11 and the air inlet chamber 12 inside the valve body 1, is output from at least one of the following: (a) the first air outlet 13; and (b) the second air outlet 14, and is conveyed along the transport pipeline to the burner component. The release of heat from the combustion of the fluid fuel under the ignition of the fire starter prompts the thermocouple to generate a high electrical potential, forming a potential difference that allows the electromagnetic valve core 22 of the electromagnetic valve assembly 2 to be kept in an attracted state, thereby providing feedback that the burner component and its fuel system are in a state of normal use, and achieving a self-locking air path.

The fluid fuel fails to be ignited if the fire starter is not functioning, and the thermocouple fails to generate a high electrical potential, and the electromagnetic valve core 22 of the electromagnetic valve assembly 2 fails to keep the electromagnetic valve core 22 in the attracted state to automatically perform a reset action, and a feedback is given that the burner component and its fuel system are in an inoperable state.

Further, the fuel system also includes a directional valve, which is also of mature prior art in the field, and is a directional control valve having more than two forms of flow and more than two inlets/outlets, and is a valve that achieves communication, cut-off, direction change, pressure unloading, and sequential action control of the fluid fuel. According to the working position number of the directional valve core staying in the directional valve body is categorized into two-position directional valves, three-position directional valves, and so on. Alternatively, they are categorized into two-way directional valves, three-way directional valves, four-way directional valves, and six-way directional valves according to the number of oil paths connected to the valve. Alternatively, there are manual directional valves, motorized directional valves, electrically operated directional valves, hydraulically operated directional valves, electro-hydraulic directional valves, and other types depending on the way the valve core moves. The specific type and model of the directional valve is not limited herein, and the specific model of the corresponding directional valve may be selected according to the actual requirements and structural design.

The directional valve is provided between the burner component and the one-piece combination valve, and the directional valve is configured to change a flow of fluid fuel into the burner component. Specifically, the first air outlet 13 and the second air outlet 14 of the one-piece combination valve can be connected to an inlet of the directional valve through the transport pipeline, and an outlet of the directional valve is connected to the burner component through the transport pipeline. By switching the adjustment switch of the directional valve, the fluid fuel may change the path of flow, thereby allowing the fluid fuel to be fed from the input of the burner component, and ultimately changing the position of the flame burning on the burner component.

The technical means disclosed in the solution of the present disclosure are not limited to those disclosed in the embodiments mentioned above but also include technical solutions consisting of any combination of the above technical features. It should be noted that for those skilled in the art, a plurality of improvements and modifications may be made without departing from the principles of the present disclosure. These improvements and modifications are also considered to be within the scope of protection of the present disclosure.

1. A one-piece combination valve, comprising:
a valve body, provided with an air guide chamber, an air inlet chamber, a first air outlet, and a second air outlet;
an electromagnetic valve assembly, fixedly connected to the valve body; and
a plug valve assembly, fixedly connected to the valve body, wherein a plug valve core of the plug valve assembly is driven under force to be rotated about a central axis of its own, so that at least one of the first air outlet and the second air outlet is/are in communication with the air guide chamber,
wherein the plug valve core of the plug valve assembly is translated under force toward an electromagnetic valve core of the electromagnetic valve assembly and is abutted against the electromagnetic valve core, so that the air guide chamber is in communication with the air inlet chamber.

2. The one-piece combination valve according to claim 1, wherein an air vent is configured between the air guide chamber and the air inlet chamber, an electromagnetic sealing part for sealing the air vent is configured on the electromagnetic valve core near the air vent, and the plug valve core acts on the electromagnetic valve core to drive the electromagnetic sealing part to move away from the air vent, so that the air guide chamber is in communication with the air inlet chamber.

3. The one-piece combination valve according to claim 1, wherein the plug valve core comprises a valve inner core and a plug switch member, the plug switch member is provided with a plug inner chamber capable of communicating with the air guide chamber and a first opening and a second opening both capable of communicating with the plug inner chamber, and the valve inner core is inserted into and penetrates the plug switch member;
wherein, in a closed state, a plug sidewall of the plug switch member seals the first air outlet and the second air outlet, and in an open state, one of the first opening and the second opening is at least partially in communication with the first air outlet, and the other of the first opening and the second opening is at least partially in communication with the second air outlet.

4. The one-piece combination valve according to claim 2, wherein the plug valve core comprises a valve inner core and a plug switch member, the plug switch member is provided with a plug inner chamber capable of communicating with the air guide chamber and a first opening and a second opening both capable of communicating with the plug inner chamber, and the valve inner core is inserted into and penetrates the plug switch member;
wherein, in a closed state, a plug sidewall of the plug switch member seals the first air outlet and the second air outlet, and in an open state, one of the first opening and the second opening is at least partially in communication with the first air outlet, and the other of the first opening and the second opening is at least partially in communication with the second air outlet.

5. The one-piece combination valve according to claim 3, wherein the first opening is extended along a peripheral direction of the plug switch member.

6. The one-piece combination valve according to claim 3, wherein the valve inner core is protruded along a radial direction to form a limit protrusion, an inner wall of the air guide chamber is formed with a gear limit slot, and the limit protrusion is embedded in the gear limit slot.

7. The one-piece combination valve according to claim 6, wherein a positioning structure is formed on a peripheral sidewall of the air guide chamber, the positioning structure is configured to restrict a rotation of the limit protrusion in a peripheral direction about the valve inner core, so as to guide the limit protrusion to be embedded in the gear limit slot.

8. The one-piece combination valve according to claim 6, wherein the plug switch member is provided with a guide slide groove, the guide slide groove is extended along a central axis of the plug switch member, and the limit protrusion is configured to pass through the plug switch member and slide with respect to the guide slide groove.

9. The one-piece combination valve according to claim 3, wherein the plug valve core further includes a reset elastic member, the reset elastic member is provided between the valve inner core and the plug switch member, and the reset elastic member is configured to reset the valve inner core.

10. The one-piece combination valve according to claim 3, wherein a cross-section of the plug switch member is gradually decreased from a side distal to the air inlet chamber along a central axis of the plug switch member toward a side proximal to the air inlet chamber, and the air guide chamber is adapted to the plug switch member.

11. The one-piece combination valve according to claim 1, further comprising a functional electromagnetic valve, wherein the valve body is further provided with a functional air guide chamber and an air guide through-hole, the air guide chamber is in communication with the functional air guide chamber through the air guide through-hole, a movable valve core of the functional electromagnetic valve is configured to seal or open the air guide through-hole, the functional electromagnetic valve is fixedly connected to the valve body, the first air outlet is provided on the air guide chamber, and the second air outlet is provided on the functional air guide chamber.

12. The one-piece combination valve according to claim 2, further comprising a functional electromagnetic valve, wherein the valve body is further provided with a functional air guide chamber and an air guide through-hole, the air guide chamber is in communication with the functional air guide chamber through the air guide through-hole, a movable valve core of the functional electromagnetic valve is configured to seal or open the air guide through-hole, the functional electromagnetic valve is fixedly connected to the valve body, the first air outlet is provided on the air guide chamber, and the second air outlet is provided on the functional air guide chamber.

13. A fuel system, comprising a one-piece combination valve,
wherein the one-piece combination valve comprises:
a valve body, provided with an air guide chamber, an air inlet chamber, a first air outlet, and a second air outlet;
an electromagnetic valve assembly, fixedly connected to the valve body; and
a plug valve assembly, fixedly connected to the valve body, wherein a plug valve core of the plug valve assembly is driven under force to be rotated about a central axis of its own, so that at least one of the first air outlet and the second air outlet is/are in communication with the air guide chamber,
wherein the plug valve core of the plug valve assembly is translated under force toward an electromagnetic valve core of the electromagnetic valve assembly and is abutted against the electromagnetic valve core, so that the air guide chamber is in communication with the air inlet chamber.

14. The fuel system according to claim 13, further comprising a burner component configured with a thermocouple, the first air outlet and the second air outlet of the one-piece combination valve are connected to the burner component through a transporting pipeline, and the thermocouple is electrically connected to the electromagnetic valve assembly of the one-piece combination valve.

15. The fuel system according to claim 14, further comprising a directional valve provided between the burner component and the one-piece combination valve, wherein the directional valve is configured to change a flow of fluid fuel into the burner component.

16. A temperature regulating control method, based on a fuel system, wherein the fuel system comprises a one-piece combination valve,
wherein the one-piece combination valve comprises:
a valve body, provided with an air guide chamber, an air inlet chamber, a first air outlet, and a second air outlet;
an electromagnetic valve assembly, fixedly connected to the valve body; and
a plug valve assembly, fixedly connected to the valve body, wherein a plug valve core of the plug valve assembly is driven under force to be rotated about a central axis of its own, so that at least one of the first air outlet and the second air outlet is/are in communication with the air guide chamber,
wherein the plug valve core of the plug valve assembly is translated under force toward an electromagnetic valve core of the electromagnetic valve assembly and is abutted against the electromagnetic valve core, so that the air guide chamber is in communication with the air inlet chamber,
the method comprising following steps:
step 1A: driving the plug valve core of the plug valve assembly to be abutted against the electromagnetic valve core of the electromagnetic valve assembly, and rotating the plug valve core about a central axis of its own to be in communication with the first air outlet of the valve body, so that fluid fuel is supplied to a burner component of the fuel system; and
step 2: initiating a fire starter of the burner component to ignite the fluid fuel, wherein a thermocouple on the burner component generates a high electrical potential to keep the electromagnetic valve core of the electromagnetic valve assembly to be in an attracted state, so that the fuel system is in a mild-flame state.

17. The temperature regulating control method according to claim 16, further comprising a functional electromagnetic valve, wherein the valve body is further provided with a functional air guide chamber and an air guide through-hole, the air guide chamber is in communication with the functional air guide chamber through the air guide through-hole, a movable valve core of the functional electromagnetic valve is configured to seal or open the air guide through-hole, the functional electromagnetic valve is fixedly connected to the valve body, the first air outlet is provided on the air guide chamber, and the second air outlet is provided on the functional air guide chamber.

18. The temperature regulating control method according to claim 17, wherein the step 1A is further replaceable with step 1B:
driving the plug valve core of the plug valve assembly to be abutted against the electromagnetic valve core of the electromagnetic valve assembly, and driving the plug valve core to be rotated about a central axis of its own, so as to open the first air outlet and the second air outlet; and sealing the air guide through-hole of the valve body by the movable valve core of the functional electromagnetic valve, so that the fluid fuel is supplied to the burner component of the fuel system only through the first air outlet.

19. The temperature regulating control method according to claim 18, further comprising following step 3A:
sending control instructions to the functional electromagnetic valve to drive the movable valve core to open the air guide through-hole, so that the fluid fuel is supplied to the burner component of the fuel system through the first air outlet and the second air outlet and the fuel system is a high-flame state.

20. The temperature regulating control method according to claim 16, further comprising following step 3B:
rotating the plug valve core about a central axis of its own until both of the first air outlet and the second air outlet of the valve body are opened, and sending control instructions to a functional electromagnetic valve to drive a movable valve core to open an air guide through-hole, so that the fluid fuel is supplied to the burner component of the fuel system through the first air outlet and the second air outlet and the fuel system is a high-flame state.
